(19) United States
(12) Patent Application Publication
(10) Pub. No.: US 2004/0075827 A1
(43) Pub. Date: Apr. 22, 2004

(54) Method and apparatus for measuring the refractive index of at least two samples

(75) Inventor: Michael Byrne, East Aurora, NY (US)

Correspondence Address: Hodgson Russ LLP, Intellectual Property Law Group, One M & T Plaza, Suite 2000, Buffalo, NY, 14203-2391, US

(73) Assignee: Leica Microsystems Inc., Depew, NY (US)

(21) Appl. No.: 10/274,588

(22) Filed: Oct. 21, 2002

(51) Int. Cl. G01N 21/41

(52) U.S. Cl. 356/128

(57) ABSTRACT

An apparatus for performing optical measurements comprising a first prism having a first sample surface, the first sample surface operatively arranged to receive a first sample, the first sample surface operatively arranged to reflect incident light, a first detector operatively arranged to measure intensity of light reflected from the first sample surface of said first prism, a second prism having a second sample surface, the second sample surface operatively arranged to receive a second sample, the second sample surface operatively arranged to reflect incident light, a second detector operatively arranged to measure intensity of light reflected from the second sample surface of the second prism, and, means to determine an optical characteristic based on the intensities of light measured by said first and the second detectors. The invention also includes a method for performing optical measurements.

### FIELD OF THE INVENTION

The present invention relates generally to optical instruments for measuring refractive index of a substance, and more particularly to an optical configuration and method for measuring a refractive index of a test sample and a reference sample with one device.

### BACKGROUND OF THE INVENTION

Refractometers measure the critical angle of total reflection by directing an obliquely incident non-collimated beam of light at a surface-to-surface boundary between a high refractive index prism and a sample to allow a portion of the light to be observed after interaction at the boundary. In transmitted light refractometers, light that is transmitted through the sample and prism is observed, while in reflected light refractometers, the light that is reflected due to total reflection at the surface-to-surface boundary is observed. In either case, an illuminated region is produced over a portion of a detection field of view, and the location of the shadowline between the illuminated region and an adjacent dark region in the detection field of view allows the sample refractive index to be deduced geometrically. Differential refractometers, such as that disclosed in U.S. Pat. No. 5,157,454, have been developed for measuring a difference in refractive index between a test sample and a known reference sample, whereby variable test conditions affecting the measurement result, such as sample temperature, illumination level, etc., can be “subtracted out” to yield a more accurate and precise measurement result.

However, existing differential refractometers generally are very bulky and expensive. There are a number of applications where a portable device is needed to measure an index of refraction of an unknown substance to a lesser degree of accuracy than an expensive differential refractometer.

Clearly, then, there is a longfelt need for a portable apparatus that can inexpensively measure the refractive index of a test sample in comparison to a reference sample.

### SUMMARY OF THE INVENTION

The invention broadly comprises a method and an apparatus for performing optical measurements. The apparatus comprises a first prism having a first sample surface, the first sample surface operatively arranged to receive a first sample, the first sample surface operatively arranged to reflect incident light, a first detector operatively arranged to measure intensity of light reflected from the first sample surface of said first prism, a second prism having a second sample surface, the second sample surface operatively arranged to receive a second sample, the second sample surface operatively arranged to reflect incident light, a second detector operatively arranged to measure intensity of light reflected from the second sample surface of the second prism, and, means to determine an optical characteristic based on the intensities of light measured by said first and the second detectors.

The method of the invention comprises the steps of measuring an intensity of light reflected from a first sample surface of a first prism, the first sample surface of the first prism receiving a first sample, measuring an intensity of light reflected from a second sample surface of a second prism, the second sample surface of the second prism receiving a second sample, and, determining an optical characteristic based on the measured intensities of light.

A general object of the present invention is to provide a method and apparatus for determining the index of refraction of a sample in comparison to another sample with a single apparatus.

Another object of the present invention is to provide a method and apparatus for determining the index of refraction of a sample that is portable and low in cost.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic of an embodiment of the present invention;

FIG. 2 is a front view of a detector of the present invention with a region of light reflected from a sample space incident thereon;

FIG. 3 is perspective view of an embodiment of the present invention wherein the samples are inserted in wells in the top of the apparatus housing;

FIG. 4 is a perspective view of an embodiment of the present invention wherein the samples are inserted in open well cuvettes inserted into the housing of the apparatus;

FIG. 5 is a perspective view of an embodiment of the present invention wherein one sample is inserted in an open well cuvette and one sample flows into a flow cell cuvette, wherein each cuvette is inserted into the housing of the apparatus;

FIG. 6 is a perspective view of an embodiment of the present invention wherein the samples flow into flow cell cuvettes inserted into the housing of the apparatus;

FIG. 7 is a perspective view of an open well cuvette of a preferred embodiment of the present invention;

FIG. 8 is a front view of an open well cuvette of a preferred embodiment of the present invention;

FIG. 9 is a side view of an open well cuvette of a preferred embodiment of the present invention;

FIG. 10 is a perspective view of a flow cell cuvette of a preferred embodiment of the present invention;

FIG. 11 is a front view of a flow cell cuvette of a preferred embodiment of the present invention;

FIG. 12 is a side view of a flow cell cuvette of a preferred embodiment of the present invention;

FIG. 13 is a view of a preferred embodiment of the present invention with the hinge open, to allow the prism surfaces to be cleaned;

FIG. 14 is a view of a preferred embodiment of the present invention with the hinge closed, to allow operation of the apparatus;

FIG. 15 is a schematic view of a preferred embodiment of the present invention, configured with flow cell cuvettes engaging gaskets on the sample surfaces of the prisms;

FIG. 16 is a view of a preferred embodiment of the present invention wherein the light to each prism originates from a single light source and traverses fiber optic lines that guide the light towards the sample surfaces of the prisms; and,

FIG. 17 is a view of an embodiment of the present invention wherein the user enters a tolerance and a reference sample into a closed well cuvette, a test sample flows through a flow cell cuvette, and a light indicates whether or not the test sample is within the specified tolerance of the reference sample.

### DETAILED DESCRIPTION OF THE PREFERRED EMBODIMENT

It should be appreciated that, in the detailed description of the invention that follows, like reference numbers on different drawing views are intended to identify identical structural elements of the invention in the respective views.

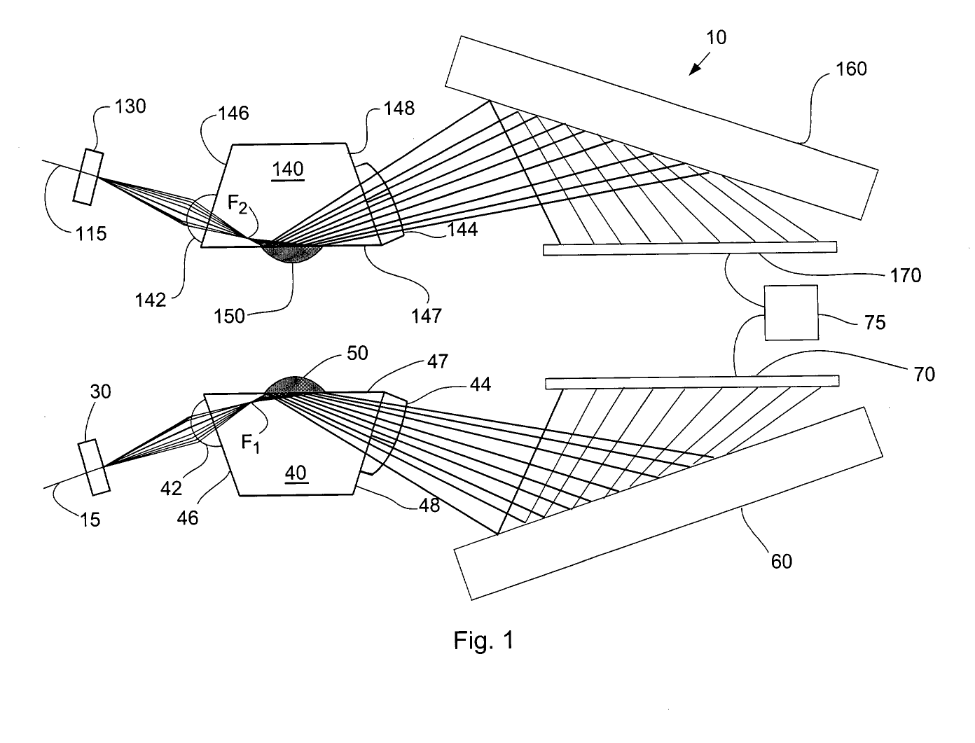

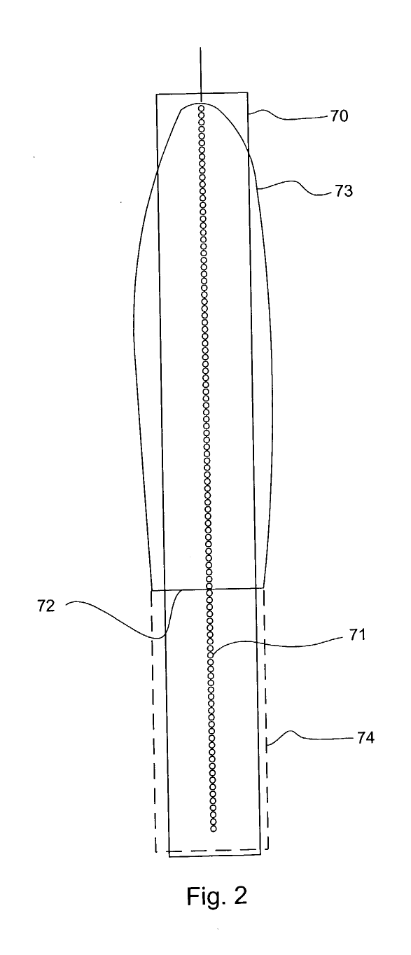

Adverting now to the drawings FIG. 1 illustrates refractometer 10 of the present invention. Refractometer 10 comprises first prism 40 having a first sample surface 47 for receiving a first sample 50 to be tested, second prism 140 having a second sample surface 147 for receiving a second sample 150 to be tested, a first detector 70, a second detector 170, and detection electronics 75. Non-parallel light is obliquely directed along beam path 15 to the surface boundary between first sample 50 and first prism 40 after traversing a diffuser 30 and a first lens 42 cemented to a light entry surface 46 of prism 40 for focusing the light at a point F₁ slightly in front of first sample surface 47. The divergent light from point F₁ includes rays having an angle of incidence greater than the critical angle of total internal reflection and rays having an angle of incidence not greater than the critical angle of total internal reflection, such that the former rays will be internally reflected at the sample/prism boundary to continue along a path to detector 70, while the latter rays will be refracted by sample 50 and pass out of the system. The internally reflected light passes successively through an exit surface 48 of prism 40 and a second lens 44 cemented to the exit surface. The light then strikes a reflective surface of a mirror 60 and is thereby redirected toward detector 70. Those skilled in the art realize that the index of refraction of sample 50 is a variable that determines the critical angle of total internal reflection at the prism-sample boundary, and thus the location of a shadowline 72 between illuminated and dark regions on detector 70, as shown in FIG. 2. In a preferred embodiment, detector 70 is a linear scanned array. In the present application, “angle of incidence” is intended to mean the angle between the sample surface of the prism and the light beam as it approaches the sample surface.

In a similar manner, non-parallel light is obliquely directed along beam path 115 to the surface boundary between second sample 150 and second prism 140 after traversing a diffuser 130 and a first lens 142 cemented to a light entry surface 146 of prism 140 for focusing the light at a point F₂ slightly in front of second sample surface 147. The divergent light from point F₂ includes rays having an angle of incidence greater than the critical angle of total internal reflection and rays having an angle of incidence not greater than the critical angle of total internal reflection, such that the former rays will be internally reflected at the sample/prism boundary to continue along a path to detector 170, while the latter rays will be refracted by sample 150 and pass out of the system. The internally reflected light passes successively through an exit surface 148 of prism 140 and a second lens 144 cemented to the exit surface. The light then strikes a reflective surface of a mirror 160 and is thereby redirected toward detector 170. A shadowline is formed on detector 170 in a similar manner as shadowline 72 is formed on detector 70, shown in FIG. 2. In a preferred embodiment, detector 170 is a linear scanned array.

As shown in FIG. 1, in a preferred embodiment, the first sample surface 47 of first prism 40 and second sample surface 147 of second prism 140 are substantially vertically oriented. In the most preferred embodiment, first sample surface 47 of first prism 40 and second sample surface 147 of second prism 140 are parallel to each other.

In a preferred embodiment, detector 70 comprises a plurality of photodiodes 71. The photodiodes 71 generate a current proportional the intensity of light incident thereon. A substantial intensity of light is incident on photodiodes 71 in the illuminated region 73 corresponding to angles of incidence greater than the critical angle. As described above, the light incident at angles less than the critical angle is refracted by the respective sample and passes out of the system. Therefore, little or no light is incident on photodiodes in the dark region 74 corresponding to angles of incidence less than the critical angle. Thus, the current levels measured by detector 70 change substantially at the location of shadowline 72.

As is known in the art of automatic refractometers, the current levels generated by photodiodes 71 of detectors 70 and 170 are digitized and processing electronics 75 perform an algorithm designed to determine the location of the shadowline transition 72 between the illuminated region 73 of each detector and the dark region 74 of each detector. The cell crossing number of the shadowline on each detector is then used to geometrically calculate the index of refraction of each of the samples. Various algorithms are available, as taught for example by U.S. Pat. Nos. 4,640,616; 5,617,201; and 6,172,746; and by commonly-owned U.S. patent application Ser. No. 09/794,991 filed Feb. 27, 2001, each of these documents being hereby incorporated by reference in the present specification. In a preferred embodiment, processing electronics 75 comprise a microprocessor programmed to perform one of the above-referenced algorithms. However, it should be readily apparent to one skilled in the art that other processing means are possible, and these modifications are within the scope of the invention as claimed.

After determining the indices of refraction, the processing electronics can determine the relationship between the two samples. Depending on the desired output, the present invention can be used, for example, to provide an index of refraction of one of the samples, an index of refraction of both of the samples, the difference in index of refraction between the samples, or an indication that the indices of refraction of the samples are within a specified tolerance of each other. It should be readily apparent to one skilled in the art that other configurations are possible, and these configurations are within the scope of the invention as claimed.

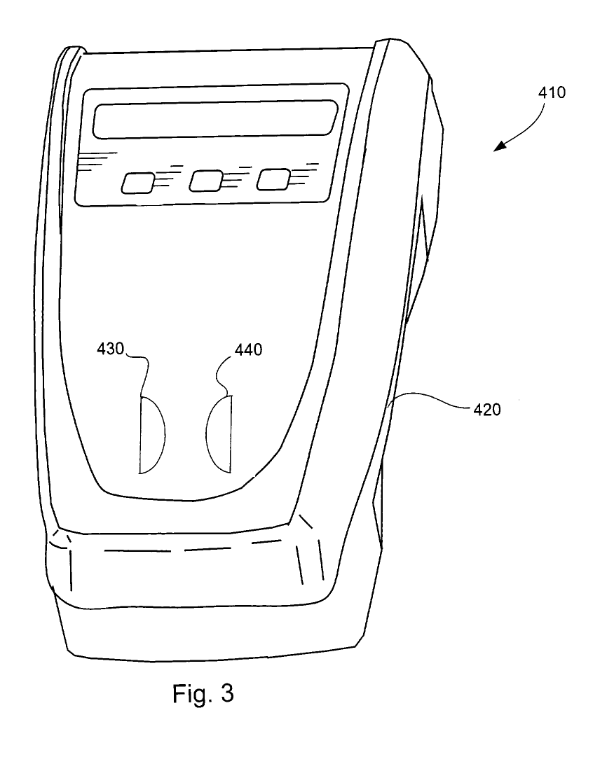

FIG. 3 shows an embodiment of the present invention wherein the samples are received by wells 430 and 440 located in a top face of housing 420 of apparatus 410. This configuration has the disadvantage that it is difficult to clean the samples out of the wells before a new sample is inserted.

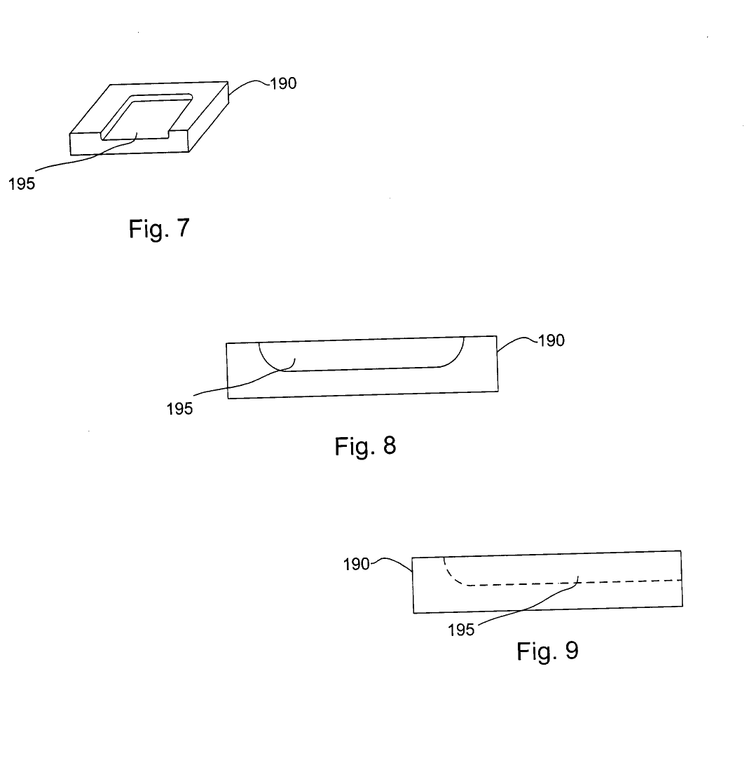

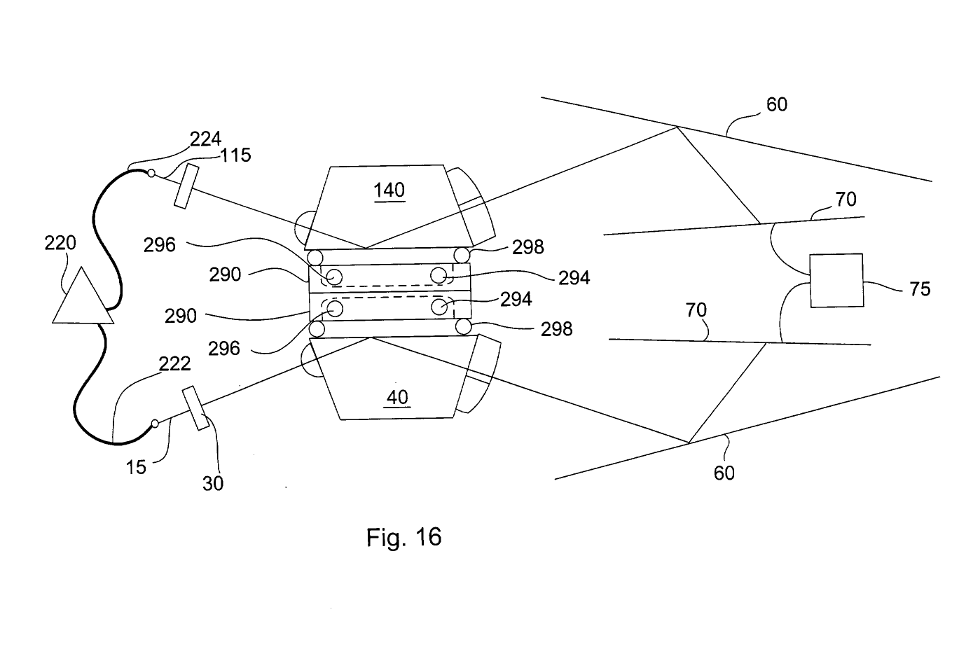

In a preferred embodiment, the samples are received by cuvettes, as shown in FIGS. 4-6. FIG. 4 shows an embodiment of the present invention wherein the samples are received in open well cuvettes 190. The structure of the open well cuvettes is shown in FIGS. 7-9. Open well cuvettes receive a sample through hole 195 and hold the sample against the respective prism sample surface. A cover 198, shown in FIG. 16, can be inserted in the open well to seal the sample in the cuvette. This is used, for example, to protect a reference sample from being contaminated by other samples.

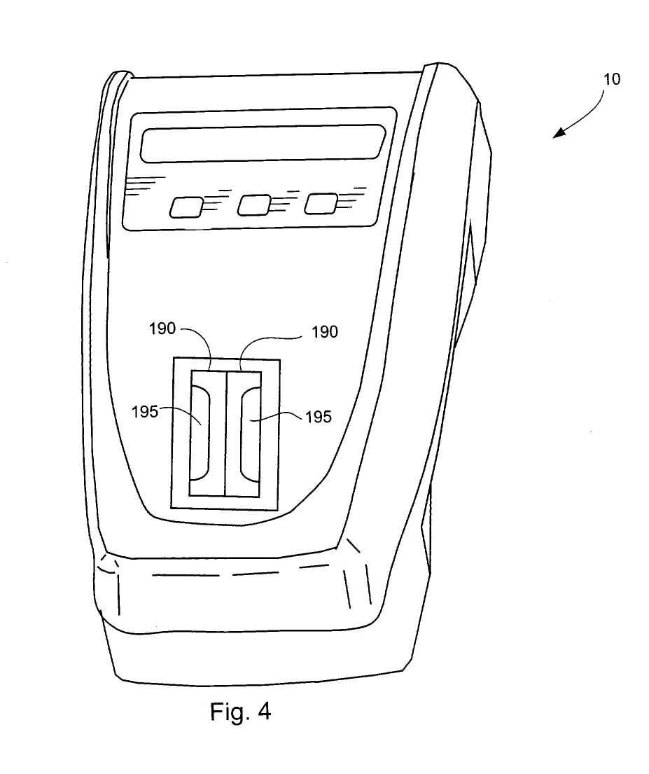

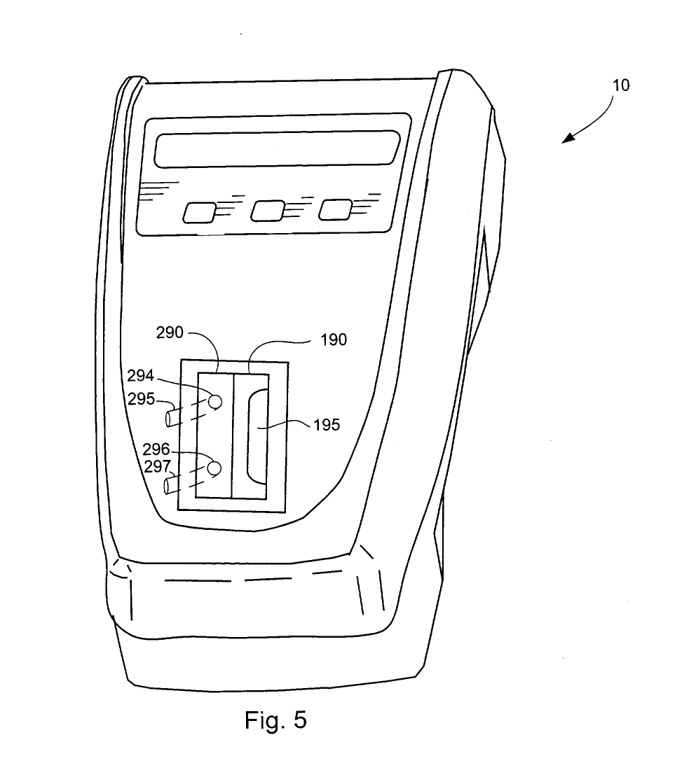

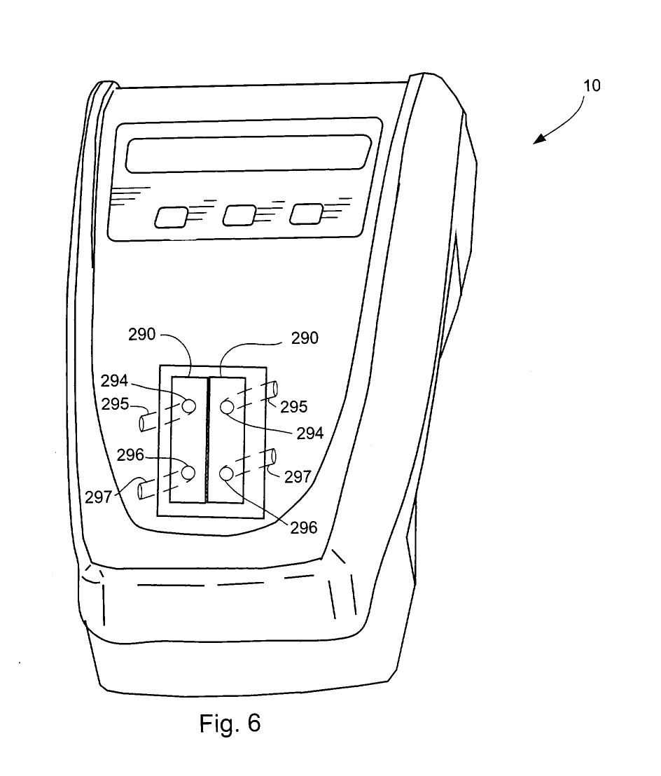

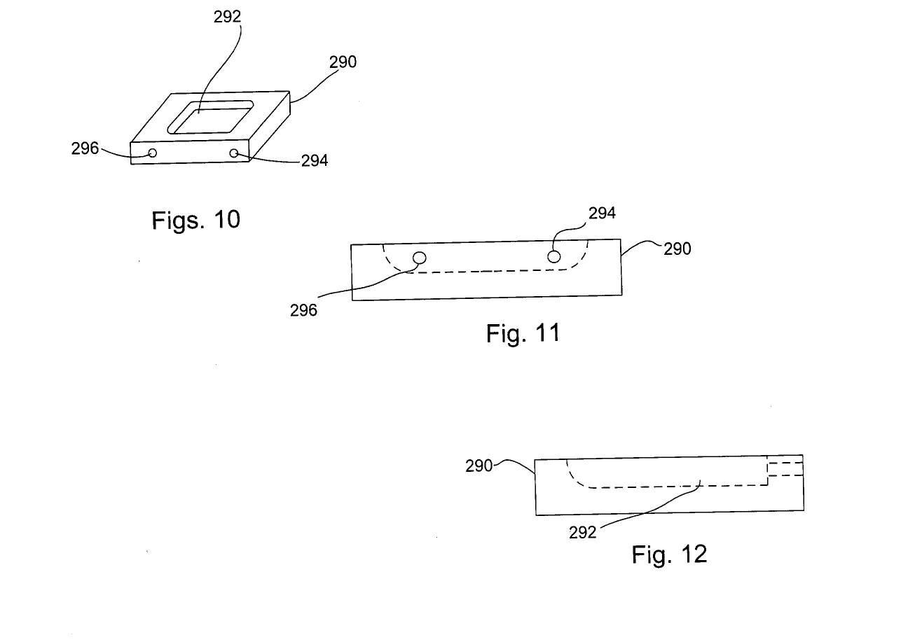

FIG. 5 shows an embodiment of the present invention wherein one sample is received in flow cell cuvette 290 and one sample is received in open well cuvette 190. The structure of flow cell cuvettes is shown in FIGS. 10-12. Flow cell cuvettes receive into chamber 292 a sample flow through a first tube 295 connected to first flow port 294. Cuvette 290 allows sample fluid to leave chamber 292 through a second tube 297 connected to second flow port 296. Thus, a continuous flow of fluid to be tested is held in contact with the sample surface of a prism. FIG. 6 shows an embodiment of the present invention wherein the samples are received in flow cell cuvettes 290. The present invention can be configured to use any combination of open well cuvettes, sealed open well cuvettes, or flow cell cuvettes.

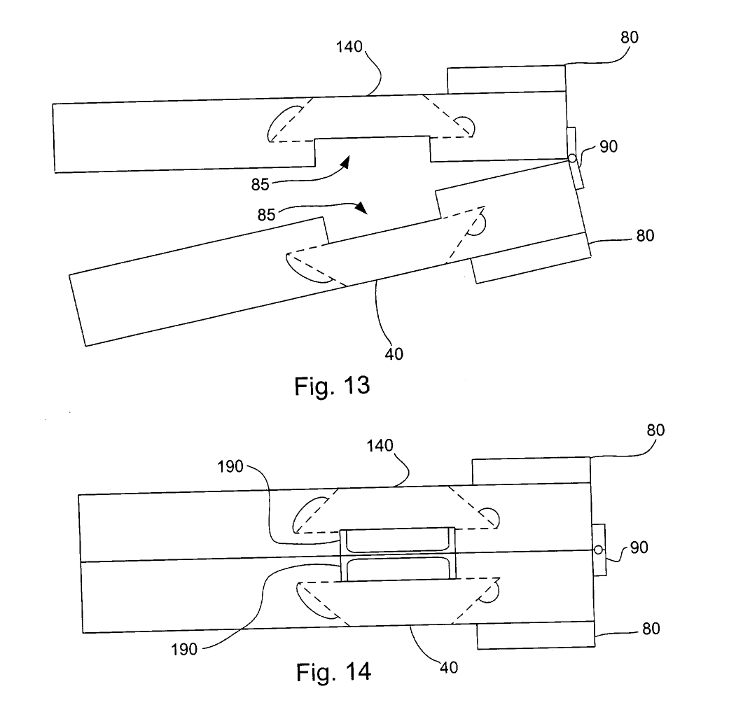

The preferred embodiment also comprises a temperature control device, designated 80 in FIGS. 13 and 14. The temperature control device 80 maintains both samples at the same temperature, to remove any errors due to temperature fluctuations. Typically, the temperature control device is a Peltier temperature control device, as is well known in the art. For example, U.S. Pat. Nos. 5,841,064 (Maekawa et al.) and 6,067,802 (Alonso), which are incorporated by reference herein, disclose Peltier temperature control devices. It should be readily apparent to one skilled in the art that other temperature control devices may be used, and these modifications are within the scope of the invention as claimed.

The preferred embodiment further comprises a means to open the apparatus to allow access to the sample surfaces of the prisms for cleaning. FIG. 13 shows apparatus 10 opening around hinge 90. Cuvettes 190 are removed from recesses 85, allowing direct access to the sample surfaces of prisms 40 and 140. When the prisms are clean, the hinge is closed, as shown in FIG. 14. Cuvettes 190 are inserted into recesses 85, and the apparatus is ready to be operated.

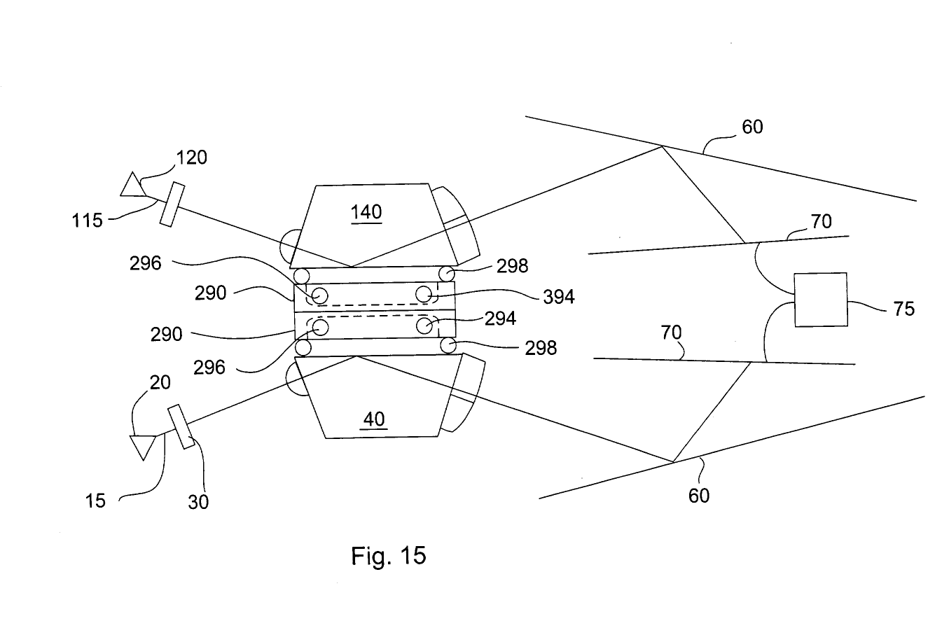

FIG. 15 shows an embodiment of the present invention configured to receive two samples in two flow cell cuvettes. This figure also shows gaskets 298. The gaskets, included in a preferred embodiment, form a fluid tight seal between the flow cell cuvette and the sample surface of the prism.

FIG. 16 shows a first light source 20 emitting light along beam path 15 and a second light source 120 emitting light along beam path 115. In a preferred embodiment, shown in FIG. 16, light source 220 emits light into first fiber optic member 222 and second fiber optic member 224. Fiber optic member 222 is arranged to emit light from source 20 along beam path 15 and second fiber optic member 224 is arranged to emit light from source 20 along beam path 115. Using light from the same source is preferred, as index of refraction is dependent on the wavelength of the light used in the measurement. Thus, any difference in wavelength between light sources 20 and 120 in FIG. 15 will introduce a source of error when the indices of refraction measured for the two samples are compared. However, it should be readily apparent to one skilled in the art that other configurations for providing light to the prisms are possible, and these modifications are within the scope of the invention as claimed.

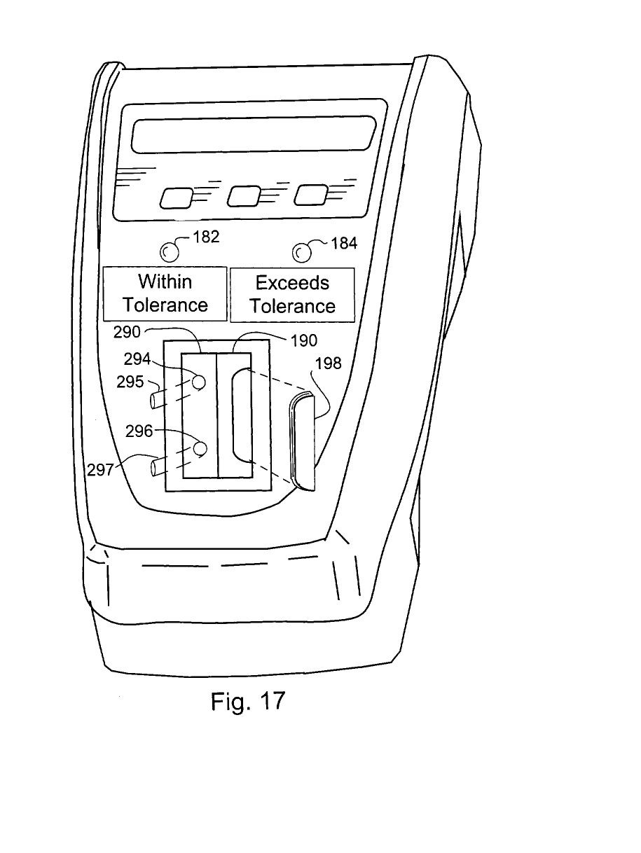

FIG. 17 shows an embodiment of the present invention wherein a tolerance is entered by a user. A reference sample is placed in open well cuvette 190 and the well is sealed with cover 198. A test sample is pumped through flow cuvette 290. Indicator light 182 stays lit as long as the index of refraction of the test sample stays within the entered tolerance of the index of refraction of the reference sample. If the index of refraction of the test sample differs from the index of refraction of the reference sample by more than the entered tolerance, indicator light 184 is lit.

The cuvettes of the present invention comprise glass, metal, plastic, or any other substance known in the art. In one embodiment, the cuvettes comprise injection molded plastic. In another embodiment, the cuvettes comprise copper.

Thus, it is seen that the objects of the present invention are efficiently obtained, although modifications and changes to the invention should be readily apparent to those having ordinary skill in the art, and these modifications are intended to be within the scope of the invention as claimed.

What is claimed is:

1. An apparatus for performing optical measurements comprising:
a first prism having a first sample surface, said first sample surface operatively arranged to receive a first sample, said first sample surface operatively arranged to reflect incident light;
a first detector operatively arranged to determine a location of a first shadowline of light reflected from said first sample surface of said first prism;
a second prism having a second sample surface, said second sample surface operatively arranged to receive a second sample, said second sample surface operatively arranged to reflect incident light;
a second detector operatively arranged to determine a location of a second shadowline of light reflected from said second sample surface of said second prism; and,
means to determine an optical characteristic based on said intensities of light measured by said first and said second detectors.

2. The apparatus recited in claim 1 wherein said first and second sample surfaces are vertically disposed.

3. The apparatus recited in claim 1 wherein said light incident on said first sample surface is emitted by a first light source and said light incident on said second sample surface of said second prism is emitted by a second light source.

4. The apparatus recited in claim 1 further comprising a light source operatively arranged to emit light along first and second fiber optic beam paths, said first fiber optic beam path operatively arranged to provide said light incident on said first sample surface of said first prism, said second fiber optic beam path operatively arranged to provide said light incident on said second sample surface of said second prism.

5. The apparatus recited in claim 1 wherein said first sample surface of said first prism is parallel to said second sample surface of said second prism.

6. The apparatus recited in claim 1 further comprising at least one Peltier element operatively arranged to control a temperature of said first prism and said first sample.

7. The apparatus recited in claim 1 further comprising at least one Peltier element operatively arranged to control a temperature of said second prism and said second sample.

8. The apparatus recited in claim 1 further comprising at least one cuvette, said cuvette operatively arranged to receive said first sample and hold said first sample in contact with said first sample surface of said first prism.

9. The apparatus recited in claim 1 further comprising at least one cuvette, said cuvette operatively arranged to receive said second sample and hold said second sample in contact with said second sample surface of said second prism.

10. The apparatus recited in claim 8 wherein said cuvette is made of glass.

11. The apparatus recited in claim 8 wherein said cuvette is made of metal.

12. The apparatus recited in claim 8 wherein said cuvette is made of plastic.

13. The apparatus recited in claim 8 wherein said cuvette is operatively arranged to receive said first sample through an open well, and said cuvette is defined to be an open well cuvette.

14. The apparatus recited in claim 13 wherein said open well cuvette is operatively arranged to be sealed after said first sample is placed within said well.

15. The apparatus recited in claim 8 wherein said cuvette is operatively arranged to receive said first sample through a flow port.

16. The apparatus recited in claim 15 further comprising a gasket operatively arranged to prevent leakage of said first sample through an interface between said cuvette and said first sample surface of said first prism.

17. The apparatus recited in claim 9 further comprising a gasket operatively arranged to prevent leakage of said second sample through an interface between said cuvette and said second sample surface of said second prism.

18. The apparatus recited in claim 1 further comprising a Peltier element operatively arranged to control a temperature of said first prism, said second prism, said first sample, and said second sample.

19. The apparatus recited in claim 1 further comprising a cuvette, said cuvette operatively arranged to receive said first sample and hold said first sample in contact with said first sample surface of said first prism, said cuvette operatively arranged to receive said second sample and hold said second sample in contact with said second sample surface of said second prism.

20. The apparatus recited in claim 18 wherein said cuvette is operatively arranged to receive said first sample through a first flow port and receive said second sample through a second flow port.

21. The apparatus recited in claim 1 wherein said optical characteristic is an index of refraction of said first sample.

22. The apparatus recited in claim 1 wherein said characteristic is a difference in index of refraction between said first sample and said second sample.

23. A method for performing optical measurements comprising:
determining a location of a first shadowline of light reflected from a first sample surface of a first prism, said first sample surface of said first prism receiving a first sample;
determining a location of a second shadowline of light reflected from a second sample surface of a second prism, said second sample surface of said second prism receiving a second sample; and,
determining an optical characteristic based on said measured intensities of light.

24. The method recited in claim 23 wherein light incident on said first sample surface is emitted by a first light source and light incident on said second sample surface of said second prism is emitted by a second light source.

25. The method recited in claim 23 wherein a light source emits light along first and second fiber optic beam paths, said first fiber optic beam path providing light incident on said first sample surface of said first prism, said second fiber optic beam path providing light incident on said second sample surface of said second prism.

26. The method recited in claim 23 wherein said first sample surface of said first prism is parallel to said second sample surface of said second prism.

27. The method recited in claim 23 wherein at least one Peltier element controls a temperature of said first prism and said first sample.

28. The method recited in claim 23 wherein at least one Peltier element controls a temperature of said second prism and said second sample.

29. The method recited in claim 23 wherein said first sample is received and held in contact with said first sample surface of said first prism by a cuvette.

30. The method recited in claim 23 wherein said second sample is received and held in contact with said second sample surface of said second prism by a cuvette.

31. The method recited in claim 23 wherein said optical characteristic is an index of refraction of said first sample.

32. The method recited in claim 23 wherein said optical characteristic is a difference in index of refraction between said first sample and said second sample.
